(19) United States
(12) Patent Application Publication
(10) Pub. No.: US 2024/0237017 A1
(43) Pub. Date: Jul. 11, 2024

(54) SEQUENTIAL ORBITAL ANGULAR MOMENTUM MODE CONFIGURATION AND INDICATION

(71) Applicant: QUALCOMM Incorporated, San Diego, CA (US)

(72) Inventors: Ahmed ELSHAFIE, San Diego, CA (US); Abdelrahman Mohamed Ahmed Mohamed IBRAHIM, San Diego, CA (US); Muhammad Sayed Khairy ABDELGHAFFAR, San Jose, CA (US); Ahmed Attia ABOTABL, San Diego, CA (US); Seyedkianoush HOSSEINI, San Diego, CA (US)

(21) Appl. No.: 18/152,067

(22) Filed: Jan. 9, 2023

(51) Int. Cl. H04W 72/231; H04W 72/11

(52) U.S. Cl. CPC H04W 72/231; H04W 72/11

(57) ABSTRACT

Certain aspects of the present disclosure provide techniques for method of wireless communications at a first user equipment (UE), comprising, receiving signaling indicating a plurality of orbital angular momentum (OAM) modes to be used across OAM transmissions and processing at least one OAM transmission, in accordance with the indication.

### BACKGROUND

### Field of the Disclosure

Aspects of the present disclosure relate to wireless communications, and more particularly, to techniques for signaling multiple orbital angular momentum (OAM) modes to use across transmissions.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communications at a first user equipment (UE). The method includes receiving signaling indicating a plurality of orbital angular momentum (OAM) modes to be used across OAM transmissions; and processing at least one OAM transmission, in accordance with the indication.

Another aspect provides a method of wireless communications at a second UE. The method includes transmitting signaling indicating, to a first UE, a plurality of OAM modes to be used across OAM transmissions; and processing at least one OAM transmission, in accordance with the indication.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example deployment in which OAM transmissions may be used.

FIG. 6 depicts an example system in which OAM transmissions may be used.

FIG. 7 illustrates an example of an orbital angular momentum (OAM) based communication system, in accordance with certain aspects of the present disclosure.

FIG. 8 illustrates an example of an orbital angular momentum (OAM) based communication system, in accordance with certain aspects of the present disclosure.

FIG. 9 illustrates an example of an OAM based communication system using uniform circular array (UCA) transmitter antennas and a set of UCA receiver antennas, in accordance with certain aspects of the present disclosure.

FIG. 10 depicts an example call flow diagram for signaling OAM modes, in accordance with certain aspects of the present disclosure.

FIGS. 11-14 depict examples of OAM modes that may be processed, in accordance with certain aspects of the present disclosure.

FIG. 15 depicts a method for wireless communications.

FIG. 16 depicts a method for wireless communications.

FIG. 17 depicts aspects of an example communications device.

### DETAILED DESCRIPTION

Aspects of the present disclosure provide apparatuses, methods, processing systems, and computer-readable mediums for signaling multiple orbital angular momentum (OAM) modes to use across transmissions.

Orbital angular momentum (OAM) is a vector quantity that is generally defined as a cross product of a position vector of an object and its linear momentum. OAM can be used to transmit information wirelessly over radio frequency (RF) spectrum. With OAM wireless transmission, information is encoded onto electromagnetic waves that have a specific OAM mode. These waves can then be transmitted through the air and received by a receiver that is equipped to detect the OAM mode of the incoming waves.

One of the main benefits of using OAM for wireless transmission is that it allows for spatial multiplexing, where multiple streams of data are transmitted simultaneously on the same frequency, using different OAM modes. Spatial multiplexing in this manner can significantly increase the capacity of a wireless communication system. OAM transmissions may also be less sensitive to interference and fading than other types of transmissions, which makes them well suited for use in challenging environments such as urban areas or inside buildings.

One potential challenge to systems utilizing OAM transmissions is how to assign OAM modes for transmissions between a transmitter (Tx) and receiver (Rx) pair and how to indicate such assignments. Aspects of the present disclosure provide flexible mechanisms for assigning and indicating OAM modes across a sequential set of transmissions. For example, the mechanisms may support semi-static, dynamic, and autonomous configuration of OAM modes, allowing adaptation to changing conditions, which may improve overall system performance.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

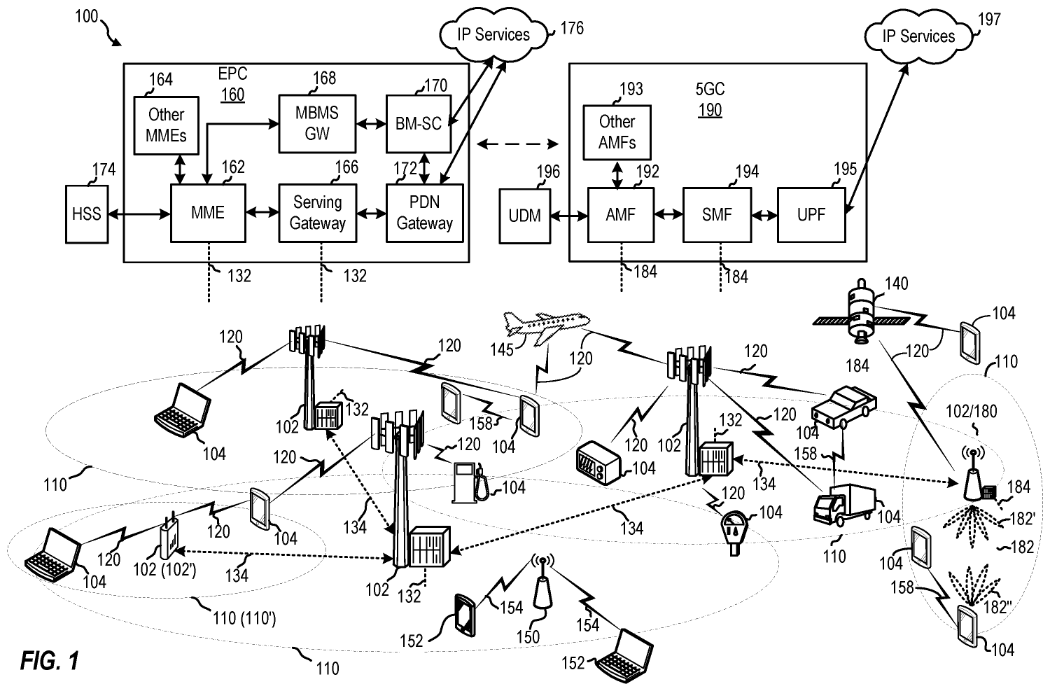

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IOT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

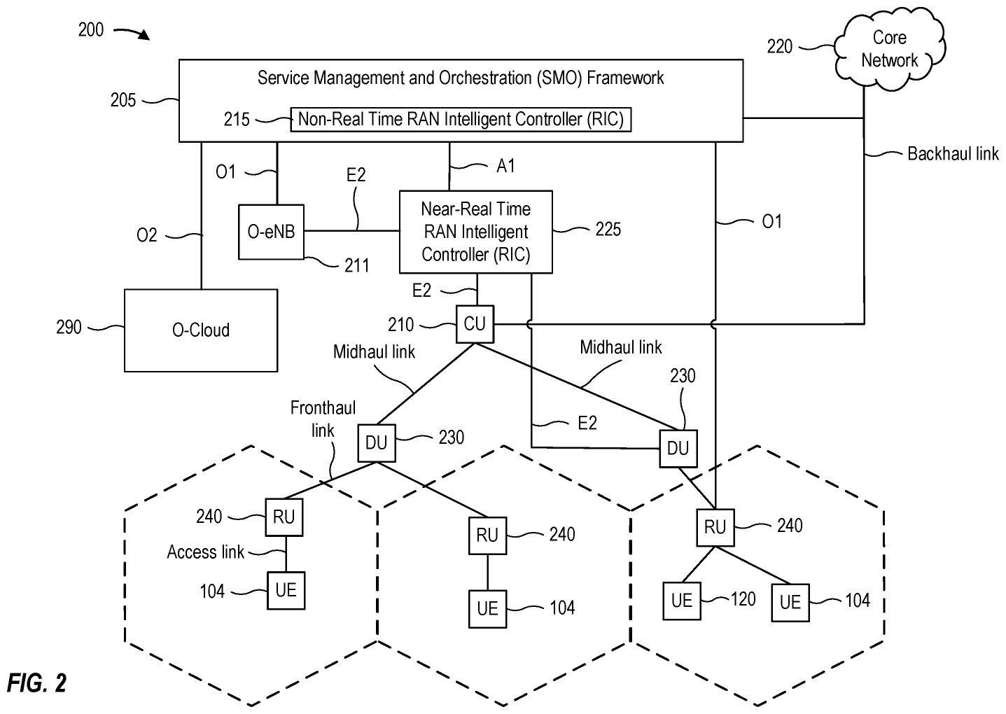

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHZ, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). Resource for sidelink communications may be allocated via one of two modes of resource allocation (RA). In a first mode (Mode 1), resources are dynamically allocated within a pool of resources that is shared between sidelink communication and non-sidelink communication. In a second mode (Mode 2), resources for sidelink communication are dedicated (not shared with non-sidelink communication). Which mode is used may depend on various factors, such as a specific application corresponding requirements. For example, mode 1 is generally used for applications with low latency and high reliability requirements, while Mode 2 is used for applications with lower reliability requirements.

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

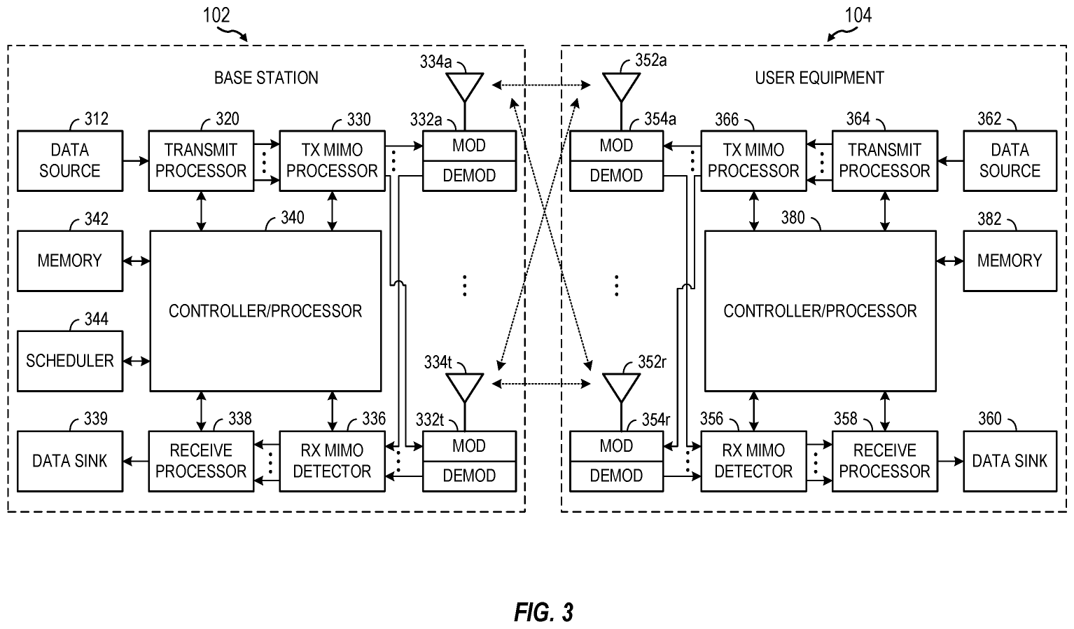

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

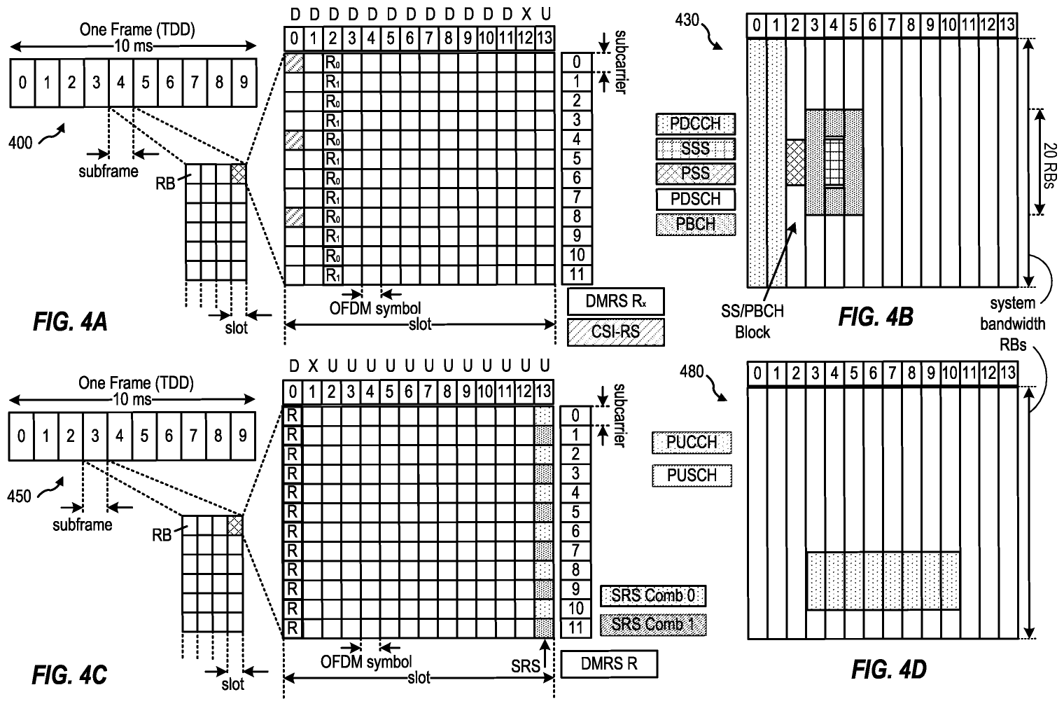

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (u) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example OAM Deployment

Orbital angular momentum (OAM) refers to the component of angular momentum of a light beam that is dependent on the spatial distribution, rather than on the polarization. The OAM component can be visualized as a waveform with a helical phase. The OAM-based waveform has different modes (due to different topological charges), which are orthogonal to each other. As traditional resources (e.g., frequency, time, and space) are efficiently utilized, the orthogonality of different OAM modes may help address capacity and performance demands of current and future wireless networks.

OAM-based communication systems may perform well in short/middle-distance wireless communication, particularly at high frequency spectrum (e.g., sub-THz, THz). Examples of such scenarios include wireless backhaul transmissions (e.g., from a base station to relay node), fixed wireless access (e.g., from a base station to a UE or Customer Premises Equipment (CPE)), or inter-device transmission (e.g., from fixed UE to fixed UE or inter-server connections in a data center).

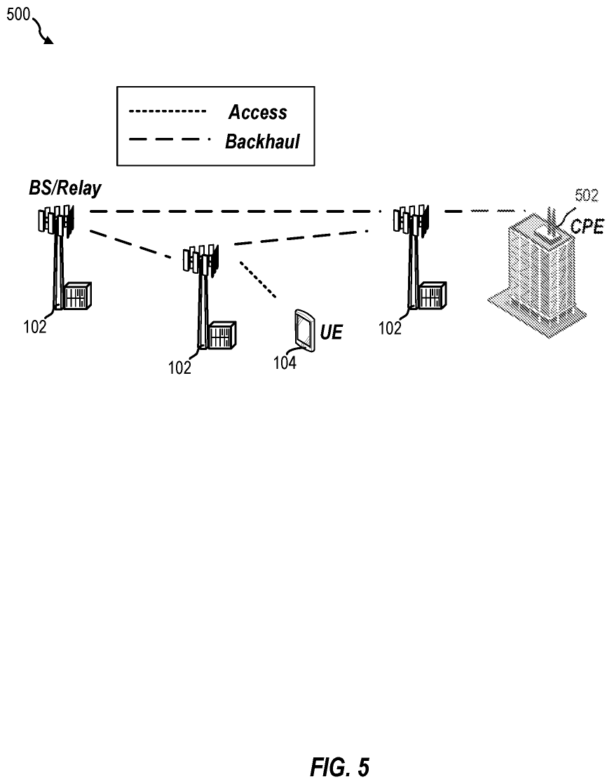

For these reasons, communication based on OAM mode-division multiplexing (MDM) may be regarded as a potential technological enhancement for future systems (e.g., 5G+ or 6G and beyond systems) that aim to provide further higher data rate than current systems. For example, OAM operation may be used in example network 500 shown in FIG. 5, that rely on integrated access and backhaul (IAB) nodes 102 to help meet demanding data requirements. As illustrated, IAB nodes may be densely deployed to provide more backhaul support between network entities, such as other IAB nodes and CPE 502, as well as access support to UEs 104.

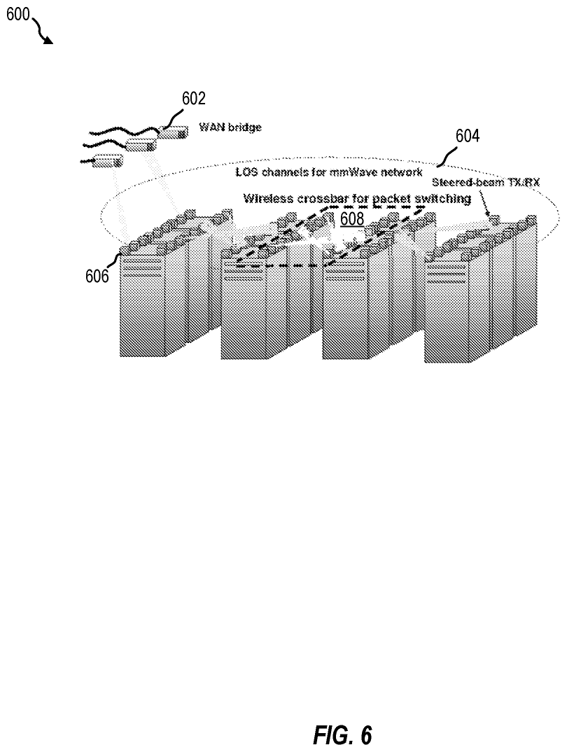

FIG. 6 illustrates another example deployment in a data center 600 where OAM operation may be used to establish a wireless network 604 for inter-device transmissions between fixed devices for a wide area network (WAN) 602. In the illustrated example, OAM transmissions between nodes 606 (capable of steered beam transmission/reception) may be used to establish a wireless crossbar 608 for packet switching.

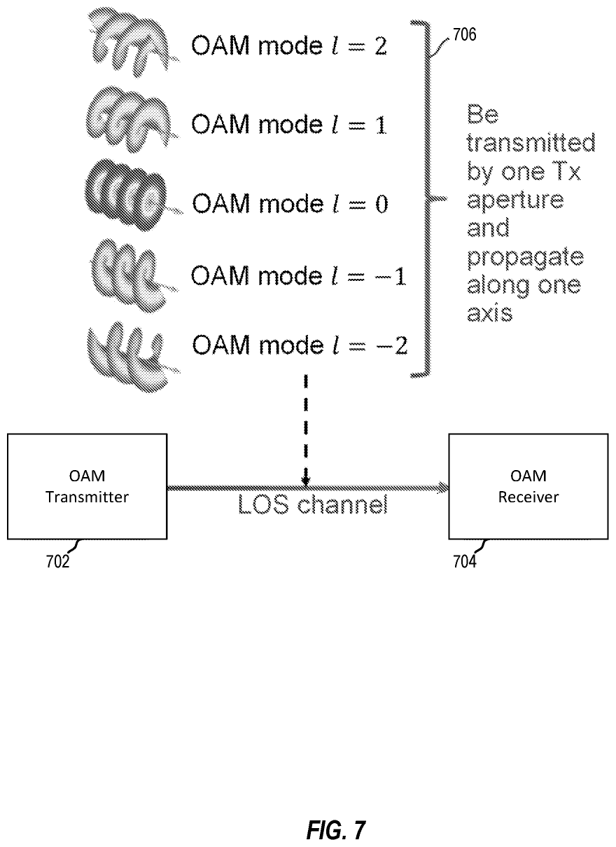

As illustrated in FIG. 7, in systems utilizing OAM multiplexing, an OAM transmitter 702 radiates multiple coaxially propagating, spatially-overlapping waves with different OAM modes 706 (e.g., OAM mode l=. . . , −2, −1,0,1,2, . . . ) each carrying a data stream through a pairs of apertures. As illustrated, electro-magnetic (EM) waves with a helical transverse phase of the form exp(iφl) carry an OAM mode waveform, where φ is the azimuthal angle and l is an unbounded integer (referred to as OAM order). Traditional EM beams (such as Gaussian beams) may be considered OAM beams with l=0.

Theoretically, these waves can be orthogonally received at the same radio (time-frequency domains) resource, and thus using OAM multiplexing can greatly improve communication spectrum efficiency with relatively low processing complexity at an OAM receiver 704. In some cases, polarization can be added to each OAM mode to double the number of orthogonal streams. Potential advantages of OAM based systems include high spatial multiplexing degree (particular in the line of site—LOS channel), resulting in a high data rate. In some cases, OAM base systems may utilize static Tx/Rx beamforming vector weights. As a result, there may be no need for inter-mode equalization at baseband (under direction alignment), which may result in relatively low baseband processing complexity.

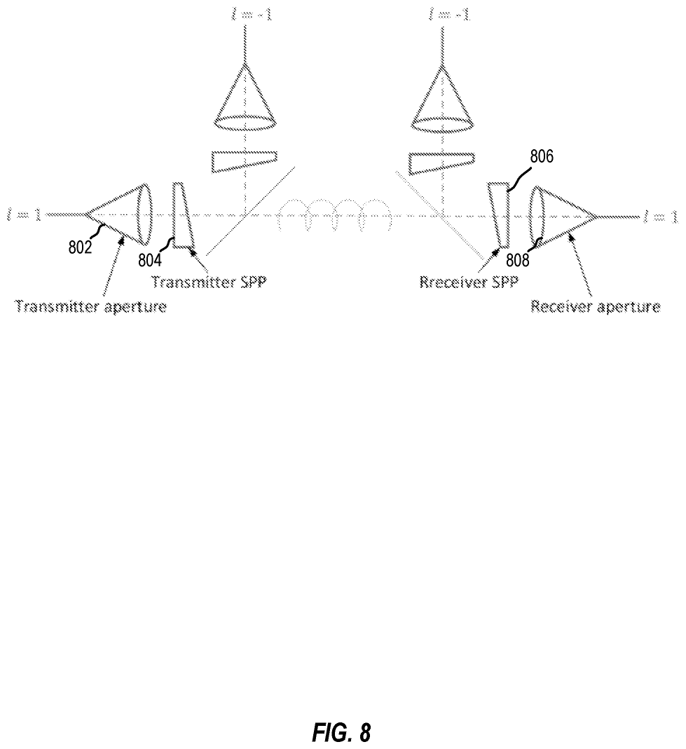

FIG. 8 illustrates one example of an OAM based communication system that uses a number of transmitter apertures 802, transmitter spiral phase plates (SPPs) 804, receiver SPPs 806 and receiver apertures 808. In general, each transmitter aperture transmits the spiral wave of one OAM mode, modulated by the transmitter SPP. In the illustrated example, OAM modes l=1 and l=−1 are transmitted.

At the receive side, each receiver aperture receives the wave of one OAM mode (l=1 or l=−1), which is demodulated by the receiver SPP. Due to the mutual orthogonality among OAM modes, the wave of one OAM mode cannot be received by the receiver aperture of the other OAM mode.

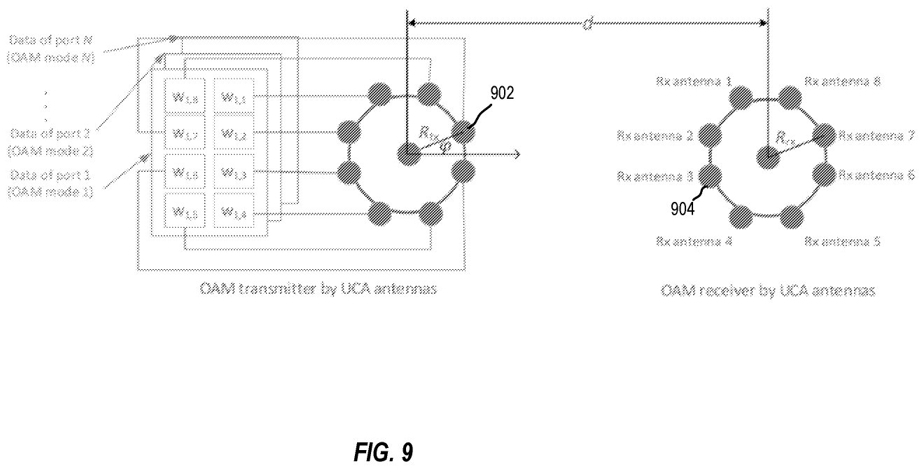

FIG. 9 illustrates another example of an OAM based communication system realized using uniform circular array (UCA) transmitter (Tx) antennas 902 and a set of UCA receiver antennas 904. As illustrated, on the transmit side, the Tx antennas may be evenly equipped (e.g., with a uniform angular spacing) in a circle with a radius Rₜₓ. By multiplying respective OAM-formed weights w₁=[w_{1,1}, w_{1,2}, . . . , w_{1,8}]^{T} onto each antenna, a signal port may generated. If the weight of each antenna is equal to exp(iφl), where φ is the angle of antenna in the circle (e.g., relative to a horizontal axis drawn from an antenna at the center of the circle), l is the OAM mode index, then this OAM-formed port is equivalent OAM mode l. By using different OAM-formed weights exp(iφl′), where l′≠l, multiple OAM modes are generated. In the illustrated example, N OAM modes are generated.

Similarly, on the receive-side, the OAM receiver also has UCA structure, with a number of Rx antennas evenly equipped (e.g., with a uniform angular spacing) in a circle with a radius Rᵣₓ. Assuming the channel matrix from each transmit antenna to each receive antenna as H, then for the OAM-formed channel matrix \tilde{H}=H·[w₁, w₂, . . . , w_{L}], any two columns of \tilde{H} are orthogonal. This generally means that all the OAM channels will have no crosstalk. This is the reason why OAM-based communication can efficiently realize a relatively high-level spatial multiplexing degree. In general, the center antenna of all UCA structure circles can be used alone to generate OAM mode 0.

Various parameters may impact the performance of OAM-based communications systems. For example, in general, a larger radius (for Rₜₓ and Rᵣₓ) results in a higher OAM multiplexing degree and a higher collective throughput (of streams on all modes). Similarly, higher frequency typically results in higher OAM multiplexing degree, but with a lower collective throughput. Depending on the (radius/frequency settings), a relatively high number (e.g., multiples of tens) of OAM modes may be used.

Various factors may be considered when choosing between UCA and SPP to transmit multiple orthogonal signals with different OAM modes. SPP-based OAM generates continuous spiral waves and, thus, can form unlimited numbers of orthogonal OAM modes in theory. In practice, however, due to propagation divergence and one mode per SPP, the number of effective OAM modes is typically limited.

UCA-based OAM generates a discrete spiral wave and, thus, can form OAM modes at most with the same number as Tx antennas. UCA-based OAM effectively belongs to multiple-input multiple-output (MIMO) whose eigen-based Tx precoding weights and Rx combining weights are constantly equal to a DFT matrix, which is generally independent of communication parameters (such as distance, aperture size and carrier frequency) and, thus, may be implemented at relatively low cost.

### Aspects Related to Sequential Orbital Angular Momentum Mode Configuration and Indication

As noted above, one potential challenge to systems utilizing OAM transmissions is how to assign OAM modes for transmissions between a transmitter (Tx) and receiver (Rx) pair and how to indicate such assignments.

Aspects of the present disclosure provide flexible mechanisms for assigning and indicating OAM modes across a sequential set of transmissions. For example, the mechanisms may support semi-static, dynamic, and autonomous configuration of OAM modes, allowing adaptation to changing conditions, which may improve overall system performance. The mechanisms may help meet time domain processing constraints, for example, that may dictate that a receiver use the same OAM modes to receive all signals within a certain time period (e.g., a slot) on a given link.

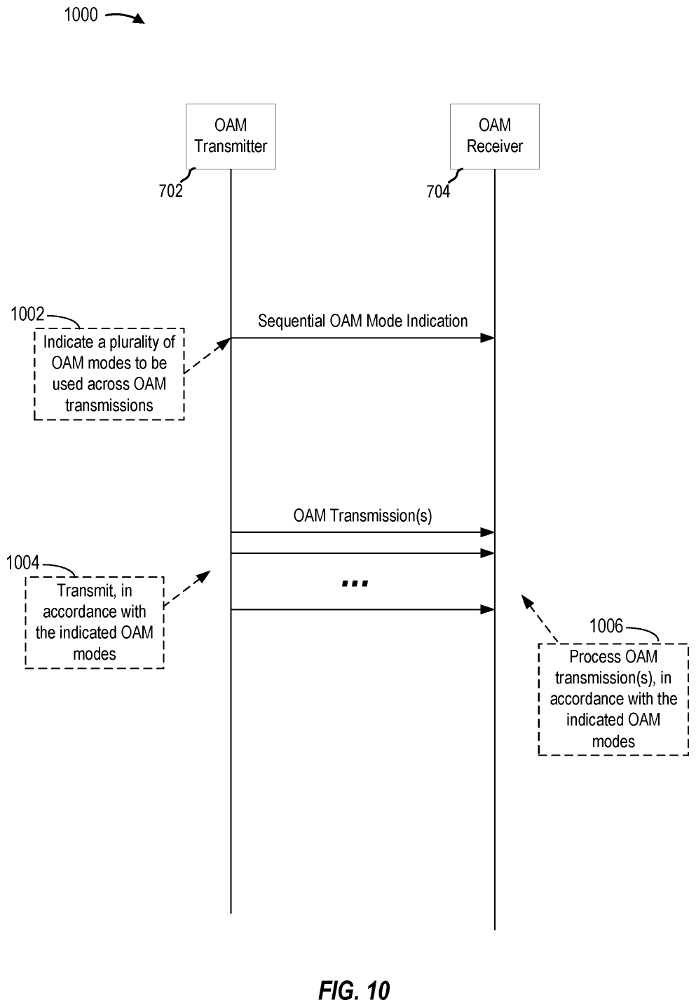

The mechanisms proposed herein for configuring and indicating OAM modes may be understood with reference to the call flow diagram 1000 of FIG. 10. The OAM transmitter OAM transmitter 702 and/or OAM receiver 704 may be examples of a UE 104 depicted and described with respect to FIGS. 1 and 3. However, in other aspects, the OAM transmitter 702 and/or OAM receiver 704 may be another type of wireless communications device.

As illustrated, at 1002, the OAM transmitter may signal, to the OAM receiver, an indication of OAM modes to be used across OAM transmissions. For example, if the OAM transmitter and OAM receiver are both UEs, the OAM modes may be used across sidelink (SL) transmissions. The OAM modes may also indicate one or more modes to be used on a cellular (e.g., Uu) link with a network entity.

As illustrated, at 1004, the OAM sends OAM transmissions in accordance with the indicated OAM modes and, at 1006, the OAM receiver process the OAM transmissions in accordance with the indicated OAM modes.

Based on the indication, the OAM receiver may know how and when to switch OAM modes to receive and process the OAM transmissions. In this manner, the mechanisms may help meet time domain processing constraints, for example, that may dictate that a receiver use the same OAM modes to receive all signals within a certain time period (e.g., an SL slot) on a given link (e.g., SL).

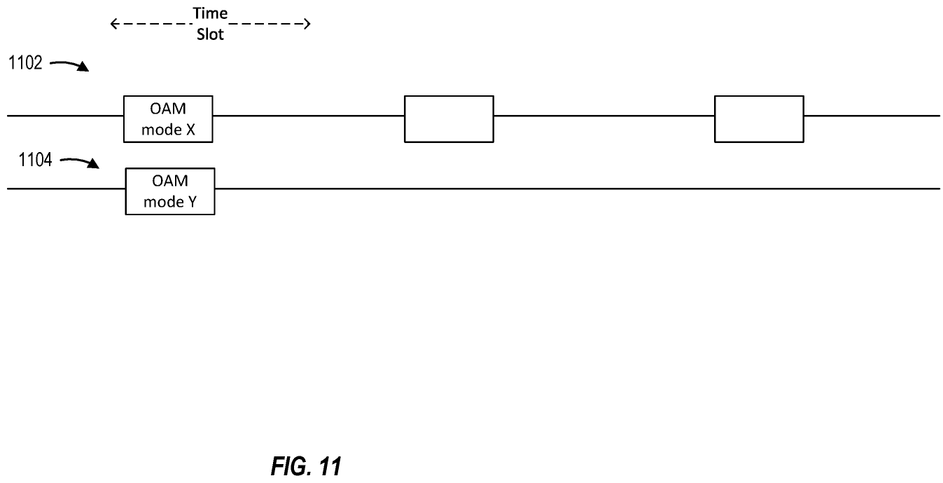

By signaling an indication of what OAM modes will be used, the OAM receiver may be able to distinguish between simultaneous transmissions sent using different OAM modes. For example, referring to FIG. 11, the indication may allow an OAM receiver to distinguish between transmissions 1102 and 1104 sent using different OAM modes. Without this information, the OAM receiver may not know the correct mode for detection.

In some cases, transmissions may occur on different bandwidth parts (BWPs), different (sidelink) resource pools, or different subbands (e.g., in the case a Uu link BWP is split into subbands). In such cases, an OAM receiver (e.g., an Rx UE) may be informed, by an OAM transmitter (e.g., a transmitter UE), about the OAM modes used across transmissions.

For example, such information may be provided via radio resource control (RRC) or medium access control (MAC) control element (CE) signaling. In some cases, this information may be provided as part of a connection mode procedure, performed between a pair of devices (e.g., gNB-UE or UE-UE) willing to communicate. As an alternative, or in addition, this information may be sent and/or updated later using dynamic or other (e.g., Layer 1, Layer 2, and/or Layer 3, L1/L2/L3) signaling.

In general, an OAM-UE can be indicated to use a certain OAM mode for reception, transmission, or both using an activation indication (signaled via L1/L2/L3 signaling) from another device (gNB or SL-UE). In some cases, the OAM-UE may use the indicated OAM mode for a given time duration and/or until a deactivation or new command is received.

In some cases, an OAM mode may be adjusted based on one or more criteria. For example, a UE may adjust the OAM mode for one or more transmissions based on a transport block size or modulation and coding scheme (MCS). In some cases, an OAM mode may be chosen to achieve a compromise of such parameters. For example, if a UE is to receive more than one packet from different devices, the UE may select the OAM mode (precoder), based on a highest priority packet (e.g., at least an expected highest priority packet).

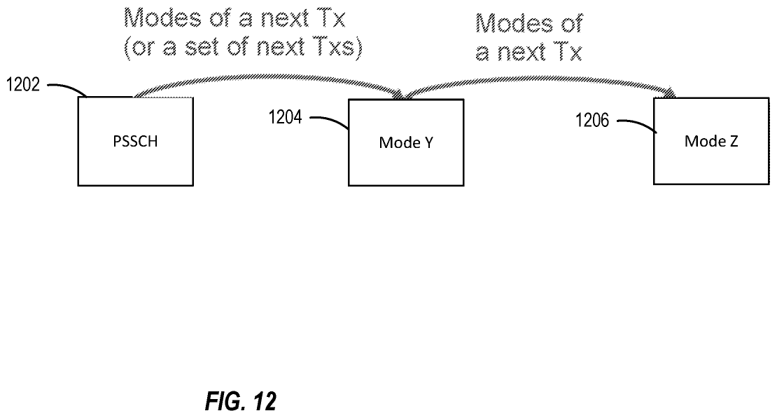

Given the importance of knowing the correct OAM mode prior to reception, in some cases, a sequential mode indication may be provided. In such cases, as illustrated in FIG. 12, downlink control information (DCI) or sidelink control information (SCI-2 or SCI-1) in sidelink of a PSSCH 1202 transmitted at time n, a Tx UE may indicate the OAM modes that it will use for one or more subsequent transmissions 1204 (at time n+x) and 1206. In such cases, a reservation (e.g., in Mode 2 RA) or a scheduled grant (SG, in Mode 1 RA) at time n+x could be a retransmission (reTx) of a same TB (e.g., since a single TB can be retransmitted maximum 2 times in SL).

In a configured grant (CG) case, a UE may indicate, in a current transmission, a next set of OAM modes used for one or more subsequent transmissions. For type 2 CG or semi-persistent-scheduled (SPS) transmissions, a network entity (e.g., a gNB) may send an indication of one or more OAM modes for a first occasion in DCI, for a Uu link or for a Tx-UE (in the case of Mode 1 RA). A similar indication may be provided for SPS OAM transmissions in the downlink.

In some cases, relatively advanced UEs may be able to quickly switch OAM modes after receiving an indication of an OAM mode. For example, such UEs may be able to quickly switch OAM modes after learning of a correct receiving OAM mode after decoding DCI in Uu link or SCI-1/SCI-2 in SL. For example, if a UE is able to process this information quickly (e.g., within 1 symbol or a fraction of a symbol), then a gNB/Tx-UE can indicate the modes in SCI-1/SCI-2 and the UE can quickly adapt by switching to the indicated OAM mode (or modes).

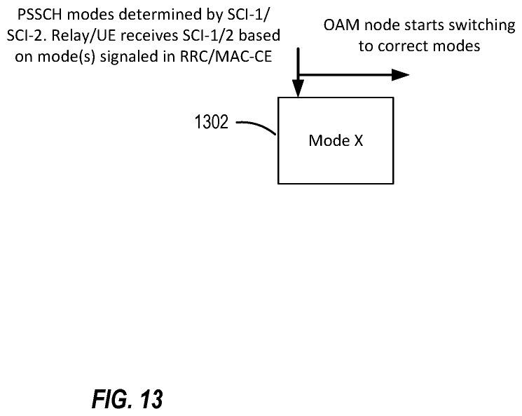

In such cases, a gNB or Tx-UE may indicate (e.g., in RRC/MAC-CE) that the gNB or Tx-UE is to adjust the OAM mode for DCI/SCI-1 (and possibly SCI-2), while data carried on PDSCH/PSSCH may be transmitted with other OAM modes. For example, as illustrated in FIG. 13, OAM mode(s) for PSSCH 1302 may be indicated by SCI-1/SCI-2 and a relay or UE may switch OAM mode(s), based on the indication. As illustrated, the OAM receiver node may start switching to the indicated modes upon decoding the information.

The signaling mechanisms proposed herein may be applied in half-duplex (HD) or full-duplex (FD) UEs, for example, for Mode 1 RA scenarios. For Uu DCI/RRC/MAC-CE signaled cases, a gNB may indicate the OAM modes used to send SCI by each Tx-UE. In some cases, a gNB may also indicate the OAM modes used by the UE to send PSFCH. This approach may have certain advantages over semi-statically configured OAM modes. Typically, such signals will be sent by a single OAM mode or multiple OAM modes, with repeating the same signal using different OAM modes.

For DCI signaled cases, a gNB may indicate OAM modes used for each (different) UE for PSSCH transmission. In some cases, a pattern of OAM modes may be signaled. For example, DCI radio network temporary identifier (RNTI) or control resource set (CORESET) may be used to indicate a certain pattern of OAM modes to be used for Tx/Rx. In such cases, a gNB may associate the OAM modes or a certain OAM mode pattern with transmission priority and/or quality of service (QOS). As an example, a first pattern (Pattern 1) may be associated with a first Priority/QoS level (Level 1). In some cases, a gNB may also indicate, to a UE, how to use the OAM modes. For example, the OAM modes may be used for repetition of same data (e.g., a same TB) or different data (e.g., different TBs) across OAM modes.

For sidelink Mode 2 RA scenarios, a gNB may assign, per resource pool, certain patterns of OAM modes for transmission and other patterns for reception. In this case, each Tx-UE may select one of the patterns randomly, for example, based on the Tx-UE ID and/or an Rx ID (or group ID in case of broadcast or groupcast signals). A Tx-UE may also select patterns based on other factors, such as a priority, QoS, or TBS. After selection, the Tx-UE may indicate the pattern in SCI (e.g., via SCI-2 to maintain SCI-1 the same for legacy UEs).

In some cases, a Tx-UE may relay information regarding OAM modes to the Rx-UE via sidelink signaling, such as PC5-RRC/MAC-CE, or sequentially using SCI (e.g., SCI-2). As used herein, sequentially may refer to one SCI indicating an OAM mode for a subsequent transmission that, in turn, may indicate an OAM mode for still another subsequent transmission.

A Tx-UE may indicate to Rx-UE which modes that the Rx-UE can use for feedback, for example for a PSFCH transmission. In some cases, a Tx-UE may determine the OAM modes (e.g., based on its needs), then signal which OAM modes in RRC/MAC-CE or SCI.

In some cases, a pattern to be used may be determined based on some common or known parameters. For example, based on a source ID, destination ID, and the like, a UE can determine which pattern to use (for Tx or Rx). This may help allow for UEs to select different modes and for Tx and Rx UEs to be in agreement. For example, if there are X patterns, a UE selects the pattern using the following equation:

mod(source ID,X).

In some cases, which frequency resources to use for OAM-based transmissions may also be determined. For example, based on an OAM mode, a UE may determine which resource block (RB) to use for PSFCH feedback or for a PUCCH resource, so that different modes can map to different resources. Once a UE determines (obtains) the set of RBs to use, the UE may select an RB for sending acknowledgment or negative acknowledgment (A/N) feedback, for example using an equation, such as:

mod(source ID+destination ID, Y), where Y is the num of RBs;

mod(source ID)+destination ID+mode ID or index, Y); or

F(source ID, destination ID, mode ID or index), where F( )=mod( ).

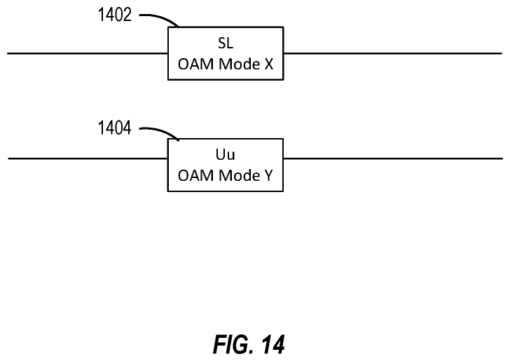

As illustrated in FIG. 14, different OAM modes may be used for transmissions 1404 on a Uu and transmissions 1402 on a sidelink (SL). In such cases, there are various options for signaling which OAM modes are used in which link. For example, a gNB may indicate which OAM mode is used in which link, for example, indicating at least set modes for Uu link transmission and reception. In some cases, based on packet priority of Uu and SL, a gNB can indicate certain modes for the higher priority TB (e.g., that may be expected to achieve better performance or higher reliability). In some cases, a UE may select modes for SL and then indicate the remaining modes to a gNB for transmission and reception at the UE.

In some cases, OAM modes with lower indices may have higher associated powers/eigenvalues. There are various options to assign such modes. According to a first option, a fairness mode assignment approach may be used, where the even modes are assigned to SL and the odd modes are assigned to the Uu link. According to a second option, the best K modes may be assigned to one interface where K is configured (e.g., via RRC/MAC-CE/DCI). This option may work based on QoS/priority (e.g., with a different value of K for different QoS). How many modes, within the K modes, to use may be signaled, for example, via DCI and/or SCI. In some cases, how many modes may be determined based on TBS or a parameter Ninfo, for example, where:

$$Ninfo = \#layers * specral\_eff * \#RE ,$$

where the number of layers (# layers) equals the number of modes (# modes), which may lead to:

$$\#modes = ceil ( Ninfo / ( \#RE * spectral\_eff ) ) ,$$

or a similar equation based on a floor function, floor( ).

### Example Operations by a User Equipment

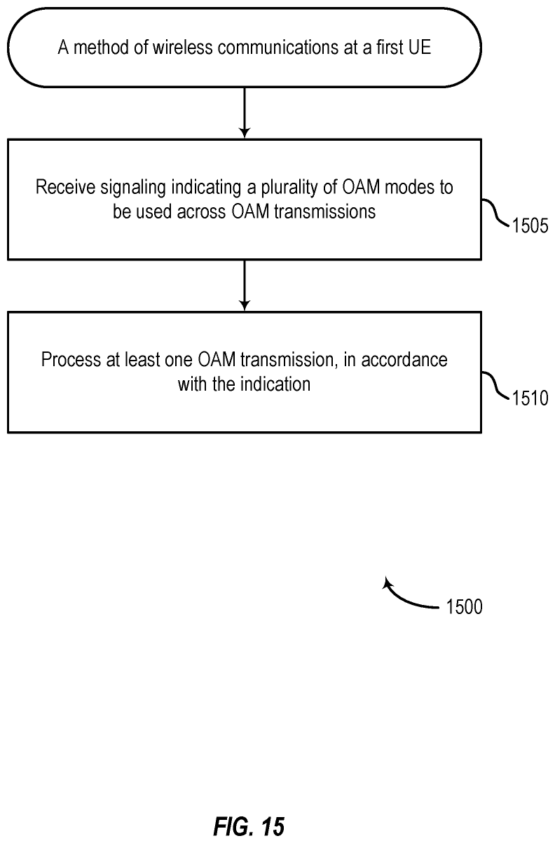

FIG. 15 shows an example of a method 1500 of wireless communications at a first UE, such as a UE 104 of FIGS. 1 and 3.

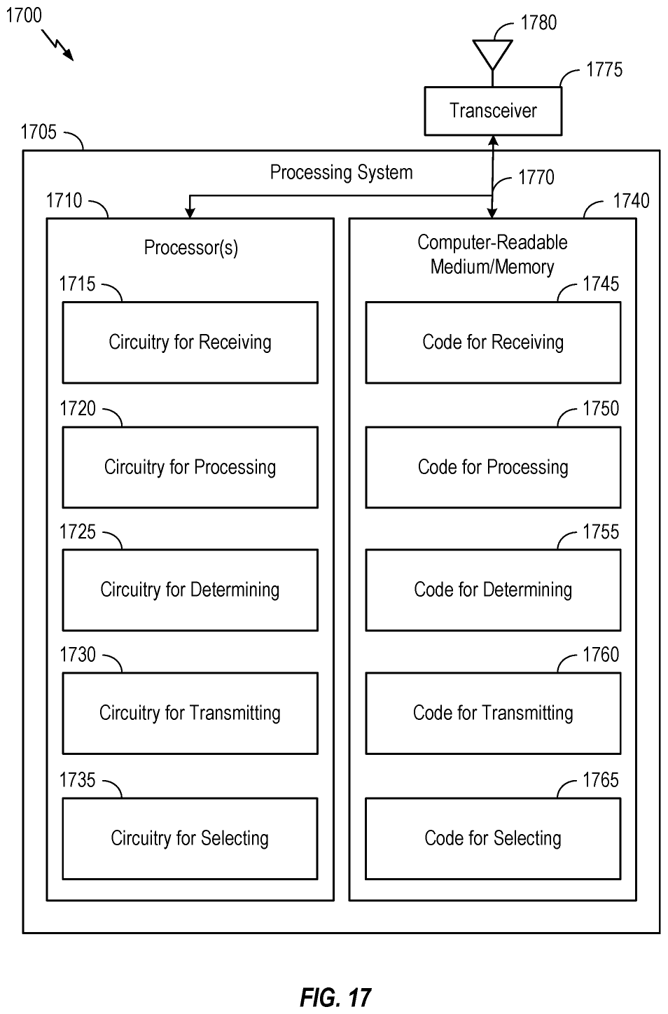

Method 1500 begins at step 1505 with receiving signaling indicating a plurality of OAM modes to be used across OAM transmissions. In some cases, the operations of this step refer to, or may be performed by, circuitry for receiving and/or code for receiving as described with reference to FIG. 17.

Method 1500 then proceeds to step 1510 with processing at least one OAM transmission, in accordance with the indication. In some cases, the operations of this step refer to, or may be performed by, circuitry for processing and/or code for processing as described with reference to FIG. 17.

In some aspects, the indication is received from at least one of: a second UE; or a network entity.

In some aspects, the signaling comprises at least one of: RRC signaling; or a MAC CE.

In some aspects, the signaling indicates that the first UE is to use a certain OAM mode for a time duration.

In some aspects: the signaling comprises an activation command; and the time duration is based on receipt of a deactivation comm.

In some aspects, processing the at least one OAM transmission comprises transmitting or receiving the at least one OAM transmission using the first OAM mode.

In some aspects, processing the at least one OAM transmission comprises selecting at least a first OAM mode based on at least one of: a TBS; a MCS; or a priority level associated with the at least one OAM transmission.

In some aspects: the first UE is scheduled to receive packets from different devices; and processing the at least one OAM transmission comprises selecting the first OAM mode based on a relative priority of the packets from the different devices.

In some aspects: the signaling is received at a first time occasion; and the at least one OAM transmission is received at a second time occasion that occurs after the first time occasion.

In some aspects, the at least one OAM transmission conveys control information that indicates OAM modes for processing subsequent OAM transmissions.

In some aspects, the control information comprises at least one of DCI or SCI.

In some aspects, the method 1500 further includes receiving an indication of resources associated with the at least one OAM transmission. In some cases, the operations of this step refer to, or may be performed by, circuitry for receiving and/or code for receiving as described with reference to FIG. 17.

In some aspects, the at least one OAM transmission utilizes SPS resources or resources indicated via a CG.

In some aspects: the signaling also schedules the at least one OAM transmission; and the signaling and the at least one OAM transmission are processed using different OAM modes.

In some aspects: the signaling indicates one or more OAM modes to use for processing at least two of SCI, PSSCH, and PSFCH transmissions.

In some aspects, the signaling indicates at least one of: one or more patterns of OAM modes; transmission priority, packet delay information, or QoS associated with the patterns; or whether to use a pattern of OAM modes across repetitions of the same TB or across different TBs.

In some aspects: the signaling is received from a transmitter sidelink UE; and the signaling indicates one of the patterns selected by the transmitter sidelink UE.

In some aspects, the signaling comprises at least one of sidelink RRC signaling, a sidelink MAC-CE, or SCI.

In some aspects, the method 1500 further includes determining, based on the first OAM mode, at least one RB to use for processing at least one of a PSFCH or a PUCCH. In some cases, the operations of this step refer to, or may be performed by, circuitry for determining and/or code for determining as described with reference to FIG. 17.

In some aspects: the signaling is received from a network entity; and the signaling indicates which OAM modes to use for a link between the first UE and the network entity and which OAM modes to use for a sidelink between UEs.

In some aspects, an algorithm determines which OAM modes are assigned to the link between the first UE and the network entity and the sidelink between UEs.

In one aspect, method 1500, or any aspect related to it, may be performed by an apparatus, such as communications device 1700 of FIG. 17, which includes various components operable, configured, or adapted to perform the method 1500. Communications device 1700 is described below in further detail.

Note that FIG. 15 is just one example of a method, and other methods including fewer, additional, or alternative steps are possible consistent with this disclosure.

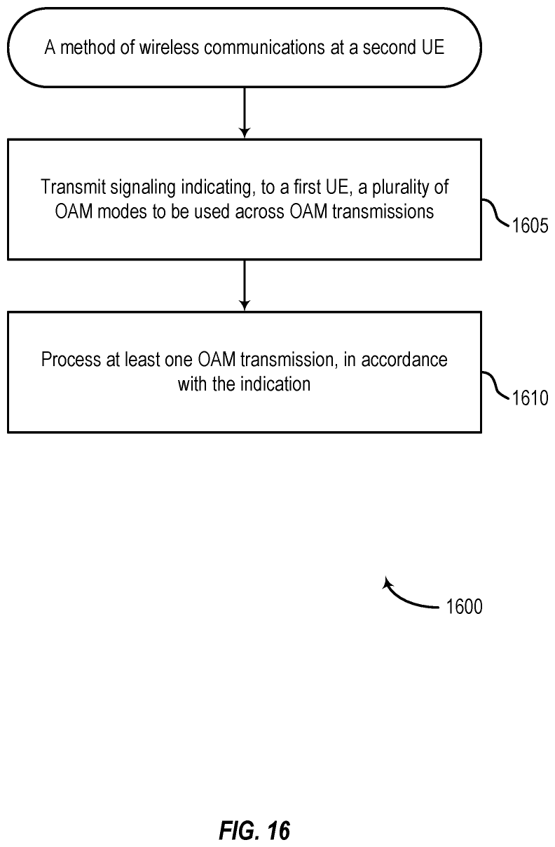

FIG. 16 shows an example of a method 1600 of wireless communications at a second UE, such as a UE 104 of FIGS. 1 and 3.

Method 1600 begins at step 1605 with transmitting signaling indicating, to a first UE, a plurality of OAM modes to be used across OAM transmissions. In some cases, the operations of this step refer to, or may be performed by, circuitry for transmitting and/or code for transmitting as described with reference to FIG. 17.

Method 1600 then proceeds to step 1610 with processing at least one OAM transmission, in accordance with the indication. In some cases, the operations of this step refer to, or may be performed by, circuitry for processing and/or code for processing as described with reference to FIG. 17.

In some aspects, the signaling comprises at least one of: RRC signaling; or a MAC-CE.

In some aspects, the signaling indicates that the first UE is to use a certain OAM mode for a time duration.

In some aspects: the signaling comprises an activation command; and the time duration is based on receipt of a deactivation comm.

In some aspects, processing the at least one OAM transmission comprises transmitting or receiving the at least one OAM transmission using the first OAM mode.

In some aspects: the signaling also schedules at least one OAM transmission; and the signaling and the at least one OAM transmission are processed using different OAM modes.

In some aspects: the signaling indicates one or more OAM modes to use for processing at least two of SCI, PSSCH, and PSFCH transmissions.

In some aspects, the signaling indicates at least one of: one or more patterns of OAM modes; transmission priority, packet delay information, or QoS associated with the patterns; or whether to use a pattern of OAM modes across repetitions of the same TB or across different TBs.

In some aspects, the method 1600 further includes selecting a pattern of OAM modes, wherein the signaling indicates the pattern. In some cases, the operations of this step refer to, or may be performed by, circuitry for selecting and/or code for selecting as described with reference to FIG. 17.

In one aspect, method 1600, or any aspect related to it, may be performed by an apparatus, such as communications device 1700 of FIG. 17, which includes various components operable, configured, or adapted to perform the method 1600. Communications device 1700 is described below in further detail.

Note that FIG. 16 is just one example of a method, and other methods including fewer, additional, or alternative steps are possible consistent with this disclosure.

### Example Communications Device

FIG. 17 depicts aspects of an example communications device 1700. In some aspects, communications device 1700 is a user equipment, such as UE 104 described above with respect to FIGS. 1 and 3.

The communications device 1700 includes a processing system 1705 coupled to the transceiver 1775 (e.g., a transmitter and/or a receiver). The transceiver 1775 is configured to transmit and receive signals for the communications device 1700 via the antenna 1780, such as the various signals as described herein. The processing system 1705 may be configured to perform processing functions for the communications device 1700, including processing signals received and/or to be transmitted by the communications device 1700.

The processing system 1705 includes one or more processors 1710. In various aspects, the one or more processors 1710 may be representative of one or more of receive processor 358, transmit processor 364, TX MIMO processor 366, and/or controller/processor 380, as described with respect to FIG. 3. The one or more processors 1710 are coupled to a computer-readable medium/memory 1740 via a bus 1770. In certain aspects, the computer-readable medium/memory 1740 is configured to store instructions (e.g., computer-executable code) that when executed by the one or more processors 1710, cause the one or more processors 1710 to perform the method 1500 described with respect to FIG. 15, or any aspect related to it; and the method 1600 described with respect to FIG. 16, or any aspect related to it. Note that reference to a processor performing a function of communications device 1700 may include one or more processors 1710 performing that function of communications device 1700.

In the depicted example, computer-readable medium/memory 1740 stores code (e.g., executable instructions), such as code for receiving 1745, code for processing 1750, code for determining 1755, code for transmitting 1760, and code for selecting 1765. Processing of the code for receiving 1745, code for processing 1750, code for determining 1755, code for transmitting 1760, and code for selecting 1765 may cause the communications device 1700 to perform the method 1500 described with respect to FIG. 15, or any aspect related to it; and the method 1600 described with respect to FIG. 16, or any aspect related to it.

The one or more processors 1710 include circuitry configured to implement (e.g., execute) the code stored in the computer-readable medium/memory 1740, including circuitry such as circuitry for receiving 1715, circuitry for processing 1720, circuitry for determining 1725, circuitry for transmitting 1730, and circuitry for selecting 1735. Processing with circuitry for receiving 1715, circuitry for processing 1720, circuitry for determining 1725, circuitry for transmitting 1730, and circuitry for selecting 1735 may cause the communications device 1700 to perform the method 1500 described with respect to FIG. 15, or any aspect related to it; and the method 1600 described with respect to FIG. 16, or any aspect related to it.

Various components of the communications device 1700 may provide means for performing the method 1500 described with respect to FIG. 15, or any aspect related to it; and the method 1600 described with respect to FIG. 16, or any aspect related to it. For example, means for transmitting, sending or outputting for transmission may include transceivers 354 and/or antenna(s) 352 of the UE 104 illustrated in FIG. 3 and/or the transceiver 1775 and the antenna 1780 of the communications device 1700 in FIG. 17. Means for receiving or obtaining may include transceivers 354 and/or antenna(s) 352 of the UE 104 illustrated in FIG. 3 and/or the transceiver 1775 and the antenna 1780 of the communications device 1700 in FIG. 17.

### Example Clauses

Implementation examples are described in the following numbered clauses:

Clause 1: A method of wireless communications at a first UE, comprising: receiving signaling indicating a plurality of OAM modes to be used across OAM transmissions; and processing at least one OAM transmission, in accordance with the indication.

Clause 2: The method of Clause 1, wherein the indication is received from at least one of: a second UE; or a network entity.

Clause 3: The method of any one of Clauses 1 and 2, wherein the signaling comprises at least one of: RRC signaling; or a MAC CE.

Clause 4: The method of any one of Clauses 1-3, wherein the signaling indicates that the first UE is to use a certain OAM mode for a time duration.

Clause 5: The method of Clause 4, wherein: the signaling comprises an activation command; and the time duration is based on receipt of a deactivation comm.

Clause 6: The method of any one of Clauses 1-5, wherein processing the at least one OAM transmission comprises transmitting or receiving the at least one OAM transmission using the first OAM mode.

Clause 7: The method of any one of Clauses 1-6, wherein processing the at least one OAM transmission comprises selecting at least a first OAM mode based on at least one of: a TBS; a MCS; or a priority level associated with the at least one OAM transmission.

Clause 8: The method of Clause 7, wherein: the first UE is scheduled to receive packets from different devices; and processing the at least one OAM transmission comprises selecting the first OAM mode based on a relative priority of the packets from the different devices.

Clause 9: The method of any one of Clauses 1-8, wherein: the signaling is received at a first time occasion; and the at least one OAM transmission is received at a second time occasion that occurs after the first time occasion.

Clause 10: The method of any one of Clauses 1-9, wherein the at least one OAM transmission conveys control information that indicates OAM modes for processing subsequent OAM transmissions.

Clause 11: The method of Clause 10, wherein the control information comprises at least one of DCI or SCI.

Clause 12: The method of any one of Clauses 1-11, further comprising: receiving an indication of resources associated with the at least one OAM transmission.

Clause 13: The method of any one of Clauses 1-12, wherein the at least one OAM transmission utilizes SPS resources or resources indicated via a CG.

Clause 14: The method of any one of Clauses 1-13, wherein: the signaling also schedules the at least one OAM transmission; and the signaling and the at least one OAM transmission are processed using different OAM modes.

Clause 15: The method of any one of Clauses 1-14, wherein: the signaling indicates one or more OAM modes to use for processing at least two of SCI, PSSCH, and PSFCH transmissions.

Clause 16: The method of Clause 15, wherein the signaling indicates at least one of: one or more patterns of OAM modes; transmission priority, packet delay information, or QoS associated with the patterns; or whether to use a pattern of OAM modes across repetitions of the same TB or across different TBs.

Clause 17: The method of Clause 16, wherein: the signaling is received from a transmitter sidelink UE; and the signaling indicates one of the patterns selected by the transmitter sidelink UE.

Clause 18: The method of Clause 17, wherein the signaling comprises at least one of sidelink RRC signaling, a sidelink MAC-CE, or SCI.

Clause 19: The method of any one of Clauses 1-18, further comprising: determining, based on the first OAM mode, at least one RB to use for processing at least one of a PSFCH or a PUCCH.

Clause 20: The method of any one of Clauses 1-19, wherein: the signaling is received from a network entity; and the signaling indicates which OAM modes to use for a link between the first UE and the network entity and which OAM modes to use for a sidelink between UEs.

Clause 21: The method of Clause 20, wherein an algorithm determines which OAM modes are assigned to the link between the first UE and the network entity and the sidelink between UEs.

Clause 22: A method of wireless communications at a second UE, comprising: transmitting signaling indicating, to a first UE, a plurality of OAM modes to be used across OAM transmissions; and processing at least one OAM transmission, in accordance with the indication.

Clause 23: The method of Clause 22, wherein the signaling comprises at least one of: RRC signaling; or a MAC-CE.

Clause 24: The method of any one of Clauses 22 and 23, wherein the signaling indicates that the first UE is to use a certain OAM mode for a time duration.

Clause 25: The method of Clause 24, wherein: the signaling comprises an activation command; and the time duration is based on receipt of a deactivation comm.

Clause 26: The method of any one of Clauses 22-25, wherein processing the at least one OAM transmission comprises transmitting or receiving the at least one OAM transmission using the first OAM mode.

Clause 27: The method of any one of Clauses 22-26, wherein: the signaling also schedules at least one OAM transmission; and the signaling and the at least one OAM transmission are processed using different OAM modes.

Clause 28: The method of any one of Clauses 22-27, wherein: the signaling indicates one or more OAM modes to use for processing at least two of SCI, PSSCH, and PSFCH transmissions.

Clause 29: The method of Clause 28, wherein the signaling indicates at least one of: one or more patterns of OAM modes; transmission priority, packet delay information, or QoS associated with the patterns; or whether to use a pattern of OAM modes across repetitions of the same TB or across different TBs.

Clause 30: The method of Clause 29, further comprising: selecting a pattern of OAM modes, wherein the signaling indicates the pattern.

Clause 31: An apparatus, comprising: a memory comprising executable instructions; and a processor configured to execute the executable instructions and cause the apparatus to perform a method in accordance with any one of Clauses 1-30.

Clause 32: An apparatus, comprising means for performing a method in accordance with any one of Clauses 1-30.

Clause 33: A non-transitory computer-readable medium comprising executable instructions that, when executed by a processor of an apparatus, cause the apparatus to perform a method in accordance with any one of Clauses 1-30.

Clause 34: A computer program product embodied on a computer-readable storage medium comprising code for performing a method in accordance with any one of Clauses 1-30.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communications at a first user equipment (UE), comprising:
receiving signaling indicating a plurality of orbital angular momentum (OAM) modes to be used across OAM transmissions; and
processing at least one OAM transmission, in accordance with the indication.

2. The method of claim 1, wherein the signaling is received from at least one of:
a second UE; or
a network entity.

3. The method of claim 1, wherein the signaling comprises at least one of:
radio resource control (RRC) signaling; or
a medium access control (MAC) control element (CE).

4. The method of claim 1, wherein the signaling indicates that the first UE is to use a certain OAM mode for a time duration.

5. The method of claim 4, wherein:
the signaling comprises an activation command; and
the time duration is based on receipt of a deactivation command.

6. The method of claim 1, wherein processing the at least one OAM transmission comprises selecting at least a first OAM mode based on at least one of:
a transport block size (TBS);
a modulation and coding scheme (MCS); or
a priority level associated with the at least one OAM transmission.

7. The method of claim 6, wherein:
the first UE is scheduled to receive packets from different devices; and
processing the at least one OAM transmission comprises selecting the first OAM mode based on a relative priority of the packets from the different devices.

8. The method of claim 1, wherein:
the signaling is received at a first time occasion; and
the at least one OAM transmission is received at a second time occasion that occurs after the first time occasion.

9. The method of claim 1, wherein the at least one OAM transmission conveys control information that indicates OAM modes for processing subsequent OAM transmissions.

10. The method of claim 9, wherein the control information comprises at least one of downlink control information (DCI) or sidelink control information (SCI).

11. The method of claim 1, further comprising receiving an indication of resources associated with the at least one OAM transmission.

12. The method of claim 1, wherein the at least one OAM transmission utilizes semi-persistently scheduled (SPS) resources or resources indicated via a configured grant (CG).

13. The method of claim 1, wherein:
the signaling also schedules the at least one OAM transmission; and
the signaling and the at least one OAM transmission are processed using different OAM modes.

14. The method of claim 1, wherein:
the signaling indicates one or more OAM modes to use for processing at least two of sidelink control information (SCI), physical sidelink shared channel (PSSCH), and physical sidelink feedback channel (PSFCH) transmissions.

15. The method of claim 14, wherein the signaling indicates at least one of:
one or more patterns of OAM modes;
transmission priority, packet delay information, or quality of service (Qos) associated with the patterns; or
whether to use a pattern of OAM modes across repetitions of a same transport block (TB) or across different TBs.

16. The method of claim 15, wherein:
the signaling is received from a transmitter sidelink UE; and
the signaling indicates one of the patterns selected by the transmitter sidelink UE.

17. The method of claim 16, wherein the signaling comprises at least one of sidelink radio resource control (RRC) signaling, a sidelink medium access control (MAC) control element (CE), or sidelink control information (SCI).

18. The method of claim 1, further comprising determining, based on a first OAM mode, at least one resource block (RB) to use for processing at least one of a physical sidelink feedback channel (PSFCH) or a physical uplink control channel (PUCCH).

19. The method of claim 1, wherein:
the signaling is received from a network entity; and
the signaling indicates which OAM modes to use for a link between the first UE and the network entity and which OAM modes to use for a sidelink between UEs.

20. The method of claim 19, wherein an algorithm determines which OAM modes are assigned to the link between the first UE and the network entity and the sidelink between UEs.

21. A method of wireless communications at a second user equipment (UE), comprising:
transmitting signaling indicating, to a first UE, a plurality of orbital angular momentum (OAM) modes to be used across OAM transmissions; and
processing at least one OAM transmission, in accordance with the indication.

22. The method of claim 21, wherein the signaling comprises at least one of:
radio resource control (RRC) signaling; or
a medium access control (MAC) control element (CE).

23. The method of claim 21, wherein the signaling indicates that the first UE is to use a certain OAM mode for a time duration.

24. The method of claim 23, wherein:
the signaling comprises an activation command; and
the time duration is based on receipt of a deactivation command.

25. The method of claim 21, wherein:
the signaling also schedules at least one OAM transmission; and
the signaling and the at least one OAM transmission are processed using different OAM modes.

26. The method of claim 21, wherein:
the signaling indicates one or more OAM modes to use for processing at least two of sidelink control information (SCI), physical sidelink shared channel (PSSCH), and physical sidelink feedback channel (PSFCH) transmissions.

27. The method of claim 26, wherein the signaling indicates at least one of:
one or more patterns of OAM modes;
transmission priority, packet delay information, or quality of service (QOS) associated with the patterns; or
whether to use a pattern of OAM modes across repetitions of a same transport block (TB) or across different TBs.

28. The method of claim 27, further comprising selecting a pattern of OAM modes, wherein the signaling indicates the pattern.

29. An apparatus for wireless communication at a first user equipment (UE), comprising a memory comprising computer-executable instructions and one or more processors configured to execute the computer-executable instructions and cause the apparatus to:
receive signaling indicating a plurality of orbital angular momentum (OAM) modes to be used across OAM transmissions; and
process at least one OAM transmission, in accordance with the indication.

30. An apparatus for wireless communication at a second user equipment (UE), comprising: a memory comprising computer-executable instructions; and one or more processors configured to execute the computer-executable instructions and cause the apparatus to:
transmit signaling indicating, to a first UE, a plurality of orbital angular momentum (OAM) modes to be used across OAM transmissions; and
process at least one OAM transmission, in accordance with the indication.
